(19) United States
(12) Patent Application Publication
(10) Pub. No.: US 2012/0030633 A1
(43) Pub. Date: Feb. 2, 2012

(54) DISPLAY SCENE CREATION SYSTEM

(75) Inventors: Fumiaki Fujimoto, Osaka (JP); Teruhisa Masui, Osaka (JP); Kazuhiko Yoda, Osaka (JP); Osamu Nishida, Osaka (JP); Jun Hamachi, Osaka (JP); Masayuki Fujisawa, Osaka (JP)

(73) Assignee: SHARPKABUSHIKI KAISHA, OSAKA -SHI (JP)

(21) Appl. No.: 13/138,749

(22) PCT Filed: Nov. 6, 2009
(86) PCT No.: PCT/JP2009/068994

§ 371 Date: Oct. 14, 2011

(30) Foreign Application Priority Data
Mar. 31, 2009 (JP) 2009-085341

(51) Int. Cl. G06F 3/041; G06F 3/033

(52) U.S. Cl. 715/863

(57) ABSTRACT

Provided is a display scene creation system that can cause a display scene to make a transition when a gesture is input to a touch panel, without a processing program that relates the touch panel to the gesture. A design of a display scene is set. One or more display components to be displayed in the set design of the display scene are set. A gesture with which the display scene makes a transition when the gesture is input to the set display components is set. A transition display scene table is provided that stores the set gesture and a post-transition display scene where the gesture and the post-transition display scene are associated with each other.

### TECHNICAL FIELD

The present invention relates to techniques for a display device equipped with a touch panel, and specifically relates to a display scene creation system, a display scene creation program, and a touch panel-equipped display system that can cause an image shown to a user to make a transition when a gesture is input to a touch panel.

### BACKGROUND ART

Recently, a display device equipped with a touch panel, as one kind of user interfaces, has been used widely in various fields such as game machines, portable telephones, PDAs, vending machines, and guideboards. Such a touch panel-equipped display device allows a user to make an intuitive operation, since displays on the touch panel and gestures input via the touch panel are associated with one another in the device.

For example, Patent Document 1 proposes the following technique relating to a portable terminal equipped with a touch panel display: when a gesture is input via the touch panel display, a function associated with the gesture is executed, and a display scene is caused to make a transition according to the execution result.

Further, Patent Document 2 proposes the following technique relating to a game system in which touch panel input is used: when a gesture is input via a touch panel display, an attack corresponding to a figure indicated by the gesture is made against an enemy character, and the display scene is caused to make a transition according to the result of the executed attack.

### PRIOR ART DOCUMENT

### Patent Document

Patent Document 1: JP 2007-279860 A
Patent Document 2: JP2008-259915 A

### DISCLOSURE OF INVENTION

### Problem to be Solved by the Invention

Conventionally, however, a touch panel-equipped display system has had no general-purpose mechanism that relates a touch panel to gestures, and therefore, the touch panel and gestures have been related through a processing program so that a transition should be made in the display scene. Such a processing program for relating the touch panel to gestures has to be created for each display scene, which leads to increases in time and effort for the program development. For example, there have been the following problems: when different gestures are expected to be input in one and the same area, the program accordingly has to be complicated, and an enormous number of man-hours are required; moreover, in order to increase the recognition accuracy, a highly sophisticated program is needed, which cannot be developed within limited time.

The present invention has been made in light of the aforementioned problems. Specifically, the object of the present invention is to provide a display scene creation system, a display scene creation program, and a touch panel-equipped display system that can cause a display scene to make a transition when a gesture is input to a touch panel, without a processing program that relates the touch panel to the gesture.

### Means for Solving Problem

To achieve the aforementioned object, a display scene creation system according to the present invention has the following characteristics: the system includes a display scene design setting section for setting a design of a display scene; a display component setting section for setting one or more display components to be displayed in the design of the display scene set by the display scene design setting section; a gesture setting section for setting a gesture with which the display scene makes a transition when the gesture is input to the display components set by the display component setting section; and a transition display scene table for storing the gesture set by the gesture setting section and a post-transition display scene where the gesture and the post-transition display scene are associated with each other.

With the above-described configuration, it is possible to provide a display scene creation system that is capable of causing a display scene to make a transition when a gesture is input to a touch panel, without a processing program that relates the touch panel to the gesture.

The display scene creation system according to the present invention is characterized in that the display component setting section sets a display component defined with a rectangular area indicated by coordinates present in the display scene.

With the above-described configuration, a post-transition display scene can be retrieved on the basis of a rectangular area where a coordinate sequence at which the touch by the user is detected is present, and a gesture indicated by the coordinate sequence in the rectangular area. Therefore, it is possible to provide a display scene creation system that is capable of causing a display scene to make a transition, without a processing program that relates the touch panel to the gesture.

The display scene creation system according to the present invention is characterized in that the display scene design setting section allocates one layer to each display scene so as to set the design of the display scene.

With the above-described configuration, it is possible to provide a display scene creation system where, even if a plurality of display scenes are set, one layer is allocated to each display scene, and therefore, an inconvenience is prevented from occurring in input to the touch panel due to the overlap of scene designs.

To achieve the above-described object, a display scene creation program according to the present invention is characterized in causing a computer to execute the steps of: setting a design of a display scene; setting one or more display components to be displayed in the design of the display scene set at the display scene design setting step; setting a gesture with which the display scene makes a transition when the gesture is input to the display components set at the display component setting step; and associating the gesture set at the gesture setting step with a post-transition display scene.

With the above-described configuration, it is possible to provide a display scene creation program that causes a display scene to make a transition when a gesture is input to the touch panel, without a processing program that relates the touch panel to the gesture.

The display scene creation program according to the present invention is characterized in that at the display component setting step, a display component defined with a rectangular area indicated by coordinates present in the display scene is set.

With the above-described configuration, a post-transition display scene can be retrieved on the basis of a rectangular area where a coordinate sequence input to the touch panel is present, and a gesture indicated by the coordinate sequence in the rectangular area. Therefore, it is possible to provide a display scene creation program that makes it possible to cause a display scene to make a transition, without a processing program that relates the touch panel to the gesture.

The display scene creation program according to the present invention is characterized in that at the display scene design setting step, one layer is allocated to each display scene so that the design of the display scene is set.

With the above-described configuration, it is possible to provide a display scene creation program where, even if a plurality of display scenes are set, one layer is allocated to each display scene, and therefore, an inconvenience is prevented from occurring in input to the touch panel due to the overlap of scene designs.

To achieve the above-described object, a touch panel-equipped display system according to the present invention is a touch panel-equipped display system that includes a display device, and a touch panel having a detection area where a touch by a user is detected, the touch panel being provided all over a display area of the display device, and the touch panel-equipped display system is characterized in that it includes a display control section that, when the touch panel detects a touch by a user on a display scene displayed in the display area of the display device, displays a post-transition display scene in the display area of the display device on the basis of a display component at which the touch by the user was detected and a gesture input with respect to the display component.

With the above-described configuration, it is possible to provide a touch panel-equipped display system that is capable of causing a display scene to make a transition when a gesture is input to a touch panel, without a processing program that relates the touch panel to the gesture.

In the touch panel-equipped display system according to the present invention, it is preferable that the display component is defined with a rectangular area indicated by coordinates in the display area of the display device; and when the touch panel detects a touch by the user on the display scene displayed in the display area of the display device, in the case where both of a rectangular area where a coordinate sequence at which the touch by the user is detected is present, and a gesture indicated by the coordinate sequence in the rectangular area, match both of an area of the display component and a gesture associated with the area of the display component, respectively, the display control section causes a post-transition display scene to be displayed in the display area of the display device.

With the above-described configuration, a post-transition display scene can be retrieved by determining whether or not both of a rectangular area where a coordinate sequence input to the touch panel is present, and a gesture indicated by the coordinate sequence in the rectangular area, match both of an area of a display component and a gesture associated with the area of the display component, respectively. Thus, a touch panel-equipped display system can be provided that is capable of causing a display scene to make a transition, without a processing program that relates the touch panel to the gesture.

In the touch panel-equipped display system according to the present invention, the display device is preferably a liquid crystal display device.

To achieve the above-described object, a driver side control module according to the present invention is characterized in that it includes the touch panel-equipped display system of the present invention according to any one of the above-described configurations, and that the driver side control module is provided somewhere around a driver seat of a mobile object.

Further, to achieve the above-described object, a mobile object according to the present invention is characterized in that it includes the touch panel-equipped display system of the present invention according to any one of the above-described configurations, and that the display device is provided at a position visible at least from a driver seat.

Further, in the mobile object according to the present invention, it is preferable that the mobile object is an automobile, and the touch panel-equipped display system is connected with ECUs (electronic control units) of respective sections of the automobile via a CAN (control area network).

### Effect of the Invention

With the present invention, the following can be provided: a display scene creation system, a display scene creation program, a touch panel-equipped display system, a driver side control module, and a mobile object that can cause a display scene to make a transition when a gesture is input to a touch panel, without a processing program that relates the touch panel to the gesture.

### BRIEF DESCRIPTION OF DRAWINGS

FIG. 1 is a block diagram illustrating an overall configuration of a display scene creation system according to an embodiment of the present invention.

FIG. 2 is a flowchart that shows a flow of scene design creation processing for creating a scene design.

FIG. 3 shows exemplary registration of freeze-frame picture items on a screen 1.

FIG. 4 shows exemplary registration of freeze-frame picture items on a screen 2.

FIG. 5 shows exemplary registration of sub-event items on the screen 2.

FIG. 6 is an exemplary screen of a scene design “Initial”

FIG. 7 shows a gesture table.

FIG. 8 is a flowchart showing a flow of a scene design transition information creation processing which is intended to create scene design transition information.

FIG. 9 shows exemplary transition information of the scene design.

FIG. 10 is a block diagram showing an overall configuration of a touch panel-equipped display system according to an embodiment of the present invention.

FIG. 11 is a flowchart showing a flow of a processing with respect to a touch panel and display in which the scene design makes a transition.

FIG. 12 shows an exemplary screen of a post-transition scene design “Navi”.

FIG. 13 illustrates an exemplary screen of a post-transition scene design “Meter”.

### DESCRIPTION OF THE INVENTION

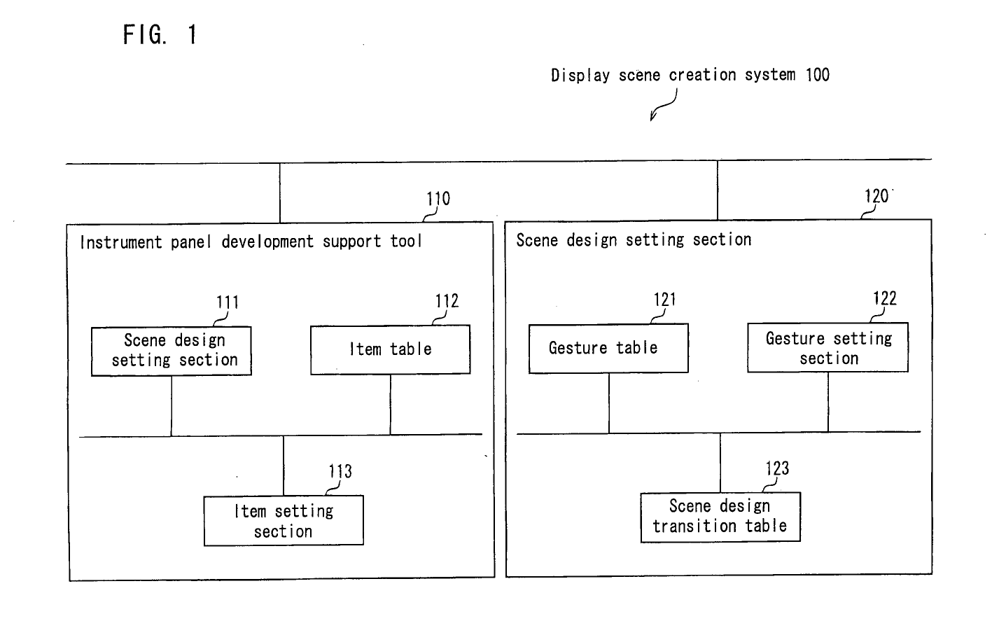

Hereinafter detailed description will be made regarding a display scene creation system according to an embodiment of the present invention, with reference to the drawings. It should be noted that a vehicle-mounted touch-panel-equipped display system is explained as a specific example of a touch panel-equipped display system herein in the description of the present embodiment, but the use of the touch panel-equipped display system according to the present invention is not limited to this use in the vehicle-mounted state. FIG. 1 is a block diagram illustrating an overall configuration of a display scene creation system 100 according to an embodiment of the present invention. The display scene creation system 100 is composed of an instrument panel development support tool 110, and a scene design director 120. Using the instrument panel development support tool 110 and the scene design director 120, a user creates a display scene beforehand with a terminal such as a personal computer. It should be noted that in this description of the present embodiment, a display scene is referred to as a scene design, and components displayed in the scene design are referred to as items. It should be noted that one layer is allocated to one scene design. Further, the instrument panel development support tool 110 is a tool for creating a scene design, and the scene design director 120 is a tool for creating transition information of the scene design.

The instrument panel development support tool 110 includes a scene design setting section 111 (display scene design setting section), an item table 112, and an item setting section 113 (display component setting section). Using the scene design setting section 111, the user sets a scene design. The item table 112 stores items to be displayed in a scene design, the items being defined with a rectangular area indicated by coordinates in the scene design. Using the item setting section 113, the user retrieves one or more items from the item table 112 and sets the same in a scene design set by the scene design setting section 111.

The user creates a scene design, using the instrument panel development support tool 110 having the above-described configuration.

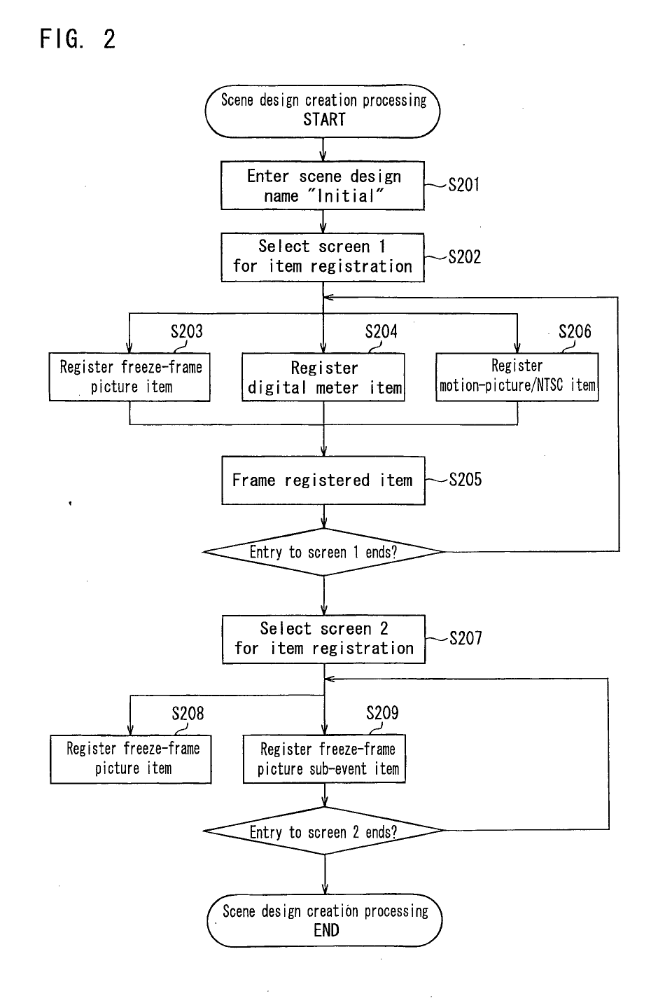

A scene design creation process through which the user creates a scene design using the instrument panel development support tool 110 is described hereinafter, with reference to the flowchart of FIG. 2. It should be noted that herein a case where a scene design “Initial” is created with use of the instrument panel development support tool 110 is described as an example. The scene design “Initial” is composed of a screen 1 and a screen 2 when it is displayed on a touch panel-equipped display device, and in the present embodiment, the screen 2 is assumed to be a screen corresponding to the touch panel.

First, with the scene design setting section 111, the user enters the name of the scene design, “Initial” (Step S201).

Next, with the scene design setting section 111, the user selects a screen on which items are to be registered, out of the screen 1 and the screen 2 of the scene design “Initial” (Step S202). Here, it is assumed that the screen 1 is selected first.

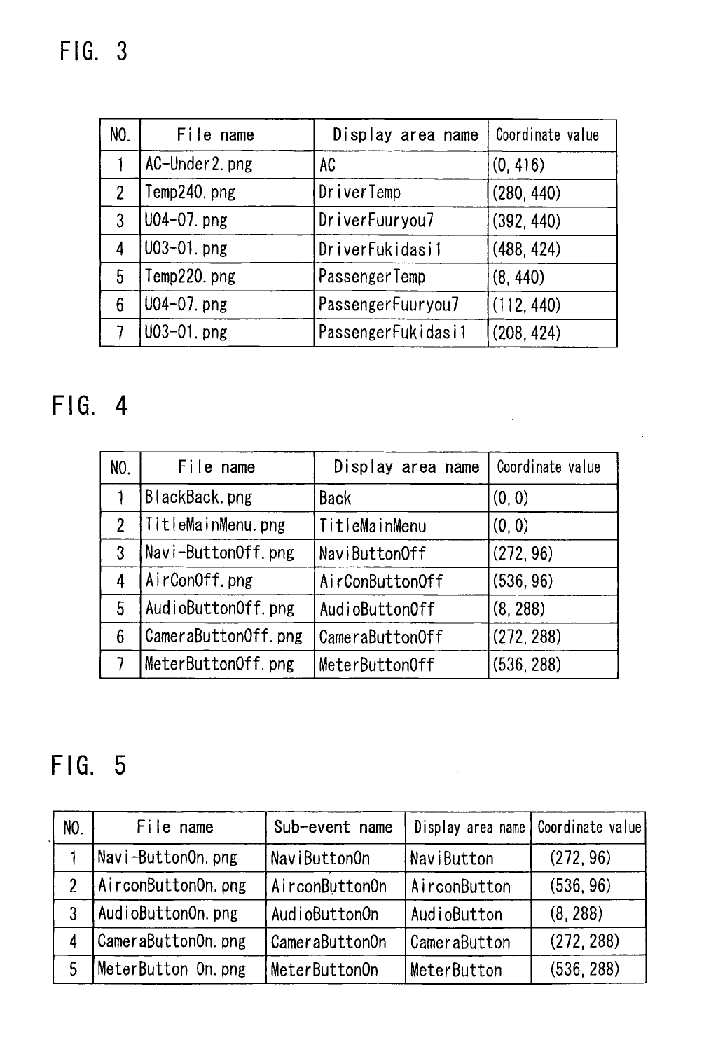

The user registers a freeze-frame picture item on the selected screen 1 (Step S203). Referring to the item table 112, and using the item setting section 113, the user selects an image file name for the freeze-frame picture item, and enters a display area name and coordinate values, so as to register the same. Here, as shown in FIG. 3, it is assumed that the following are registered as freeze-frame picture items: file name “AC-Under2.png”, display area name “AC”, and coordinate values (0, 416); file name “Temp240.png”, display area name “DriverTemp”, and coordinate values (280, 440); file name “U04-07.png”, display area name “DriverFuuryou7”, and coordinate values (392, 440); file name “U03-01.png”, display area name “DriverFukidasi1”, and coordinate values (488, 424); file name “Temp220.png”, display area name “PassengerTemp”, and coordinate values (8, 440); file name “U04-07.png”, display area name “PassengerFuuryou7”, and coordinate values (112, 440); and file name “U03-01.png”, display area name “PassengerFukidashi1”, and coordinate values (208, 424).

Alternatively, the user registers a digital meter item on the selected screen 1 (Step S204). Using the item setting section 113, the user sets a font for each digit of the digital meter, and enters the name of the digital meter, a display area name thereof, and coordinate values thereof so as to register the same. Here, it is assumed that, as digital meter items, a date meter is registered at coordinate values (600, 424) in a display area named “Date2”, and a time meter is registered at coordinate values (680, 456) in a display area named “TIME”.

Next, the user frames the freeze-frame picture items and the digital meters registered in the selected screen 1 (Step S205).

Next, the user registers motion-picture/NTSC items in the selected screen 1 (Step S206). The user enters a name of a display area where a motion picture from a preset device such as a navigator is to be displayed, so as to register the same. Here, it is assumed that the display area name “Map” is registered.

Next, with the scene design setting section 111, the user selects the screen 2 on which items are to be registered next, out of the screen 1 and the screen 2 of the scene design “Initial” (Step S207).

Next, the user registers freeze-frame items on the selected screen 2 (Step S208). Referring to the item table 112, and using the item setting section 113, the user selects image file names of freeze-frame items and enters display area names and coordinate values so as to register the same. Here, as shown in FIG. 4, it is assumed that the following are registered as freeze-frame items: file name “BlackBack.png”, display area name “Back”, and coordinate values (0, 0); file name “TitleMainMenu.png”, display area name “TitleMainMenu”, and coordinate values (0, 0); file name “Navi-ButtonOff.png”, display area name “Navi-ButtonOff”, and coordinate values (272, 96); file name “AirConOff.png”, display area name “AirConButtonOff”, and coordinate values (536, 96); file name “AudioButtonOff.png”, display area name “AudioButtonOff”, and coordinate values (8, 288); file name “CameraButtonOff.png”, display area name “CameraButtonOff”, and coordinate values (272, 288); and file name “MeterButtonOff.png”, display area name “MeterButtonOff”, and coordinate values (536, 288).

Next, the user registers sub-event items on the selected screen 2 (Step S209). Referring to the item table 112, and using the item setting section 113, the user selects image file names of sub-event items and enters display area names and coordinate values so as to register the same. Here, it is assumed that the following are registered as sub-event items, as shown in FIG. 5: file name “Navi-ButtonOn.png”, sub-event name “NaviButtonOn”, display area name “NaviButton”, and coordinate values (272, 96); file name “AirConOn.png”, sub-event name “AirconButtonOn”, display area name “AirConButton”, and coordinate values (536, 96); file name “AudioButtonOn.png”, sub-event name “AudioButtonOn”, display area name “AudioButton”, and coordinate values (8, 288); file name “CameraButtonOn.png”; sub-event name “CameraButtonOn”, display area name “CameraButton”, and coordinate values (272, 288); and file name “MeterButtonOn.png”, sub-event name “MeterButtonOn”, display area name “MeterButton”, and coordinate values (536, 288).

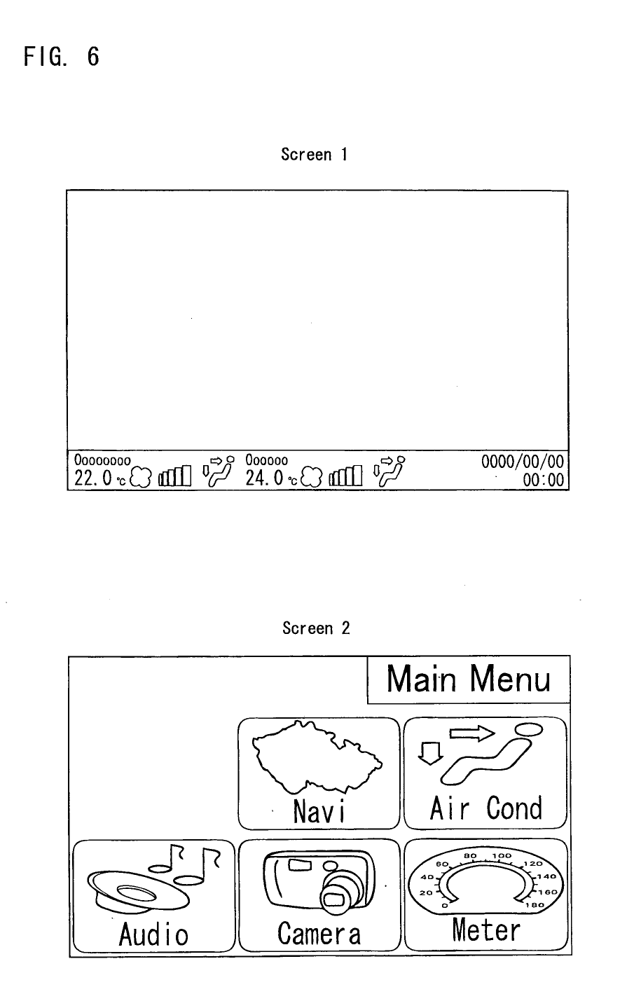

The screens 1 and 2, that is, the scene design “Initial”, in which the items have been registered as described above with use of the instrument panel development support tool 110, become screens as shown in FIG. 6.

Regarding the scene design “Initial” thus created, the user creates scene design transition information, using the scene design director 120 coordinated with the instrument panel development support tool 110.

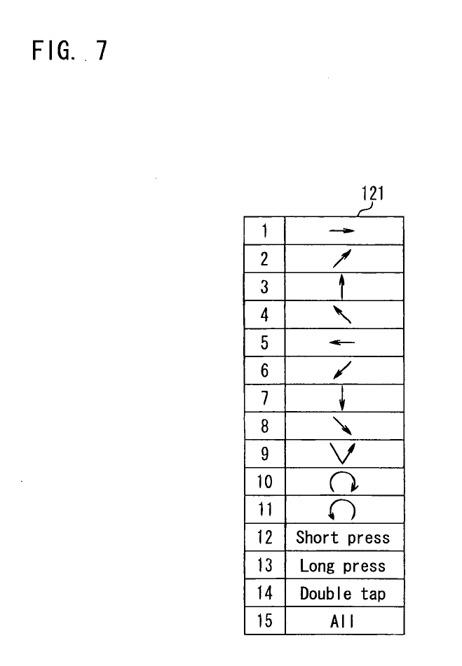

The scene design director 120 includes a gesture table 121, a gesture setting section 122, and a scene design transition table 123 (transition display scene table). The gesture table 121 is a table that stores patterns of gestures. For example, the gesture table 121 in accordance with a specific example shown in FIG. 7 stores gesture patterns of 15 types. Referring to the gesture table 121, and using the gesture setting section 122, the user sets patterns of gestures that react to items set with use of the item setting section 113 of the instrument panel development support tool 110. The scene design transition table 123 is a table that stores transition information that associates a gesture set by the user with use of the gesture setting section 122, and a post-transition scene design.

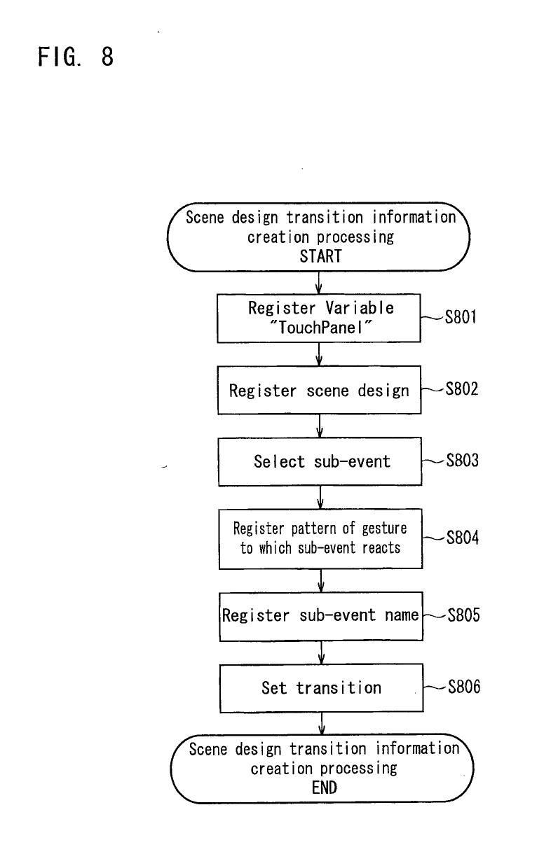

Using the scene design director 120 having the above-described configuration, the user creates transition information of a scene design. With reference to the flowchart of FIG. 8, the following explains a scene design transition information creating process, which is a process through which the user creates scene design transition information with use of the scene design director 120. It should be noted that a case where transition information of the scene design “Initial” is created with use of the scene design director 120 is explained here as an example.

First, with the gesture setting section 122, the user selects a variable “TouchPanel” as an execution conditions for sub-events, and registers the same (Step S801).

Next, with the gesture setting section 122, the user selects a scene design on which the sub-events are to be displayed, and registers the same (Step S802). Here, it is assumed that the scene design “Initial” is selected.

Next, with the gesture setting section 122, the user displays, as thumbnails, the sub-events to be displayed in the selected scene design “Initial”, and selects sub-events that the user wants to register, out of the sub-events displayed as thumbnails (Step S803).

Next, with the gesture setting section 122, the user refers to the gesture table 121 storing the patterns of gestures of 15 types, and selects a pattern of the gesture to which the selected sub-event reacts, and registers the same (Step S804).

Next, with the gesture setting section 122, the user enters the name of the sub-event that is executed when the gesture to which the sub-event reacts is input, and registers the same (Step S805).

Next, after the sub-event of the registered sub-event name is executed, the user, with the gesture setting section 122, executes transition setting for causing the scene design to make such a transition that the scene design changes to the designated one after a designed time period (Step S806).

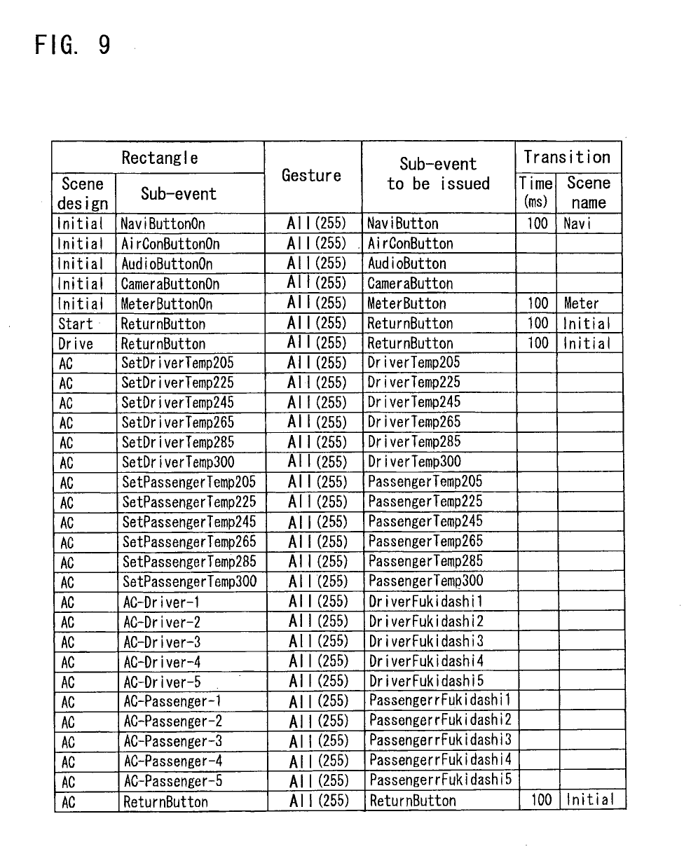

Here, it is assumed that the following are set as scene design transition information, as shown in FIG. 9: scene design “Initial”, sub-event “NaviButtonOn”, gesture “All”, sub-event to be executed “NaviButton”, transition time “100 ms”, and transition scene name “Navi”; scene design “Initial”, sub-event “AirconButtonOn”, gesture “All”, and sub-event to be executed “AirconButton”; and scene design “Initial”, sub-event “AudioButtonOn”, gesture “All”, sub-event to be executed “AudioButton”; scene design “Initial”, sub-event “MeterButtonOn”, gesture “All”, sub-event to be executed “MeterButton”, transition time “100 ms”, and transition scene name “Meter”.

Then, the scene design director 120 associates the scene design registered by the instrument panel development support tool 110 with the scene design registered by the scene design director 120.

The user uses the scene design created by the instrument panel development support tool 110 as described above, and the transition information of the scene design created by the scene design director 120, by downloading them into a touch panel-equipped display system 200 that will be described in detail below.

Hereinafter detailed description will be made regarding an embodiment of the present invention in which the present invention is applied to an automobile (car) with reference to the drawings. It should be noted that objects to which the present invention is applied are not limited to automobiles. The present invention is applicable to, in addition to automobiles, various vehicles (travelling means or transport means) such as motorbikes, motor tricycles, special vehicles, railway vehicles, and other street vehicles, amphibious vehicles, airplanes, and ships. Further, the present invention is also applicable, not only to the vehicles mainly intended for travelling or transport as described above, but also simulators that allow people to virtually experience the driving of the above-described various vehicles. In the present application, such vehicles and simulators as described above are generally referred to as “mobile objects”.

An automobile cockpit module (driver side control module) in which the touch panel-equipped display system 200 according to the present embodiment is incorporated includes a liquid crystal display device 210 for displaying a synthetic image of an automotive instrument panel, instead of a conventional automotive instrument panel that includes conventional analog meters such as speed meter and a tachometer, and indicator lamps composed of LEDs, etc.

It should be noted that the liquid crystal display device 210 is not a segment-type liquid crystal display instrument that is often used also in a conventional automobile, but a dot-matrix-type liquid crystal panel display device. The liquid crystal display device 210 is capable of displaying images of any patterns, and hence functions as an automotive information display device by displaying a synthetic image in which images of various types of elements such as meters and indicator lamps are combined. Further, the liquid crystal display device 210 is capable of displaying, not only the image of an instrument panel, but also images picked up by a vehicle-mounted camera provided on the back or side of an automobile, navigation images, TV-broadcast images, reproduced images from vehicle-mounted DVD players, and the like together.

The liquid crystal display device 210 is attached to an instrument panel (not shown) as a frame body of a cockpit module (not shown), at a position on the backside of a steering wheel (not shown). The cockpit module includes, in addition to the liquid crystal display device 210, an air conditioning unit (not shown), an air conditioning duct (not shown) for introducing air from the air conditioning unit into the inside of the automobile, an audio module (not shown), a lamp switch (not shown), a steering mechanism (not shown), an air bag module (not shown), and the like. It should be noted that the liquid crystal display device 210 may be provided at another position such as the center of the instrument panel, that is, a position between the driver seat and the front passenger, seat.

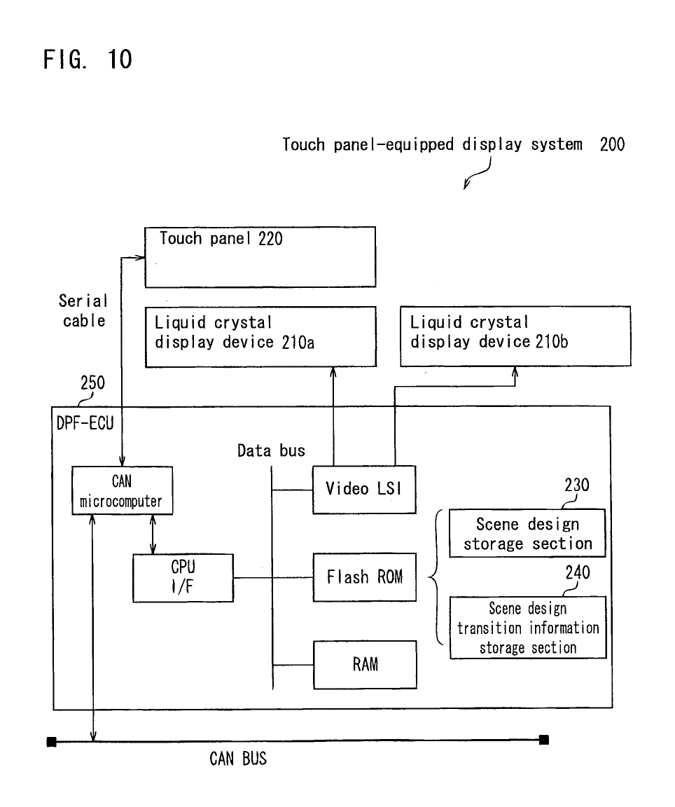

FIG. 10 is a block diagram illustrating an exemplary overall configuration of the touch panel-equipped display system 200 according to the present embodiment. The touch panel-equipped display system 200 includes liquid crystal display device 210 (210a, 210b), a touch panel 220, a flash ROM (a scene design storage section 230, a scene design transition information storage section 240), a video image processing LSI, a DPF-FCU 250 (display control section), a CAN microcomputer, a CPU I/F, and a RAM.

All over a display area of the liquid crystal display device 210, there is provided a touch panel 220 having a detection area for detecting a touch by the user. A scene design created by the instrument panel development support tool 110 is downloaded and stored in the scene design storage section 230. Transition information of the scene design created by the scene design director 120 is downloaded and stored in the scene design transition information storage section 240.

The scene design displayed on the liquid crystal display device 210 is controlled by the DPF-ECU 250. The DPF-ECU 250 is connected with various ECUs provided at respective sections of the automobile via an in-vehicle LAN. The DPF-ECU 250 obtains information representing states of respective sections of the automobile (state information, hereinafter referred to as “state information D” unless otherwise specifically provided) from each ECU via the in-vehicle LAN in a predetermined cycle. It should be noted that the “predetermined cycle” is set to an arbitrary length according to the specification of the in-vehicle LAN and the like. Further, state information D is transmitted from respective ECUs in different cycles in some cases. In such a case, the sampling cycle for sampling the state information D at the DPF-ECU 250 may be set in accordance with the respective state information transmission cycles. However, the interface standard of the in-vehicle LAN to which the present invention can be applied is not limited to CAN. For example, any vehicle-mounted network in accordance with various in-vehicle LAN interface standards, such as LIN (Local Interconnect Network), MOST (Medial Oriented Systems Transport), and FlexRay is applicable to the present invention.

The DPE-ECU 250 reflects the obtained state information of the automobile to the scene design created by the instrument panel development support tool 110 of the display scene creation system 100, and causes the scene design to which the information has been reflected to be displayed in the display area of the liquid crystal display device 210.

The “state information” is, as described above, information representing the state of each section of the automobile, and can include, not only information relating to a state of a mechanical motion of each section of the automobile (e.g., driving speed, engine speed), but also various types of information, such as that relating to a state not directly relevant to a mechanical motion of each section (e.g., remaining fuel level, room temperature). Examples of the state information include the following, though these examples are merely examples in the case of a passenger car, and do not limit the present invention: engine speed; driving speed; select position; shift position; operation status of direction indicators; whether lights are lit or not; whether doors and a trunk lid are open or closed; whether doors are locked or not; states of wheels; whether air bags have any abnormalities; whether seat-belts are worn appropriately; temperature of air at outlets of air conditioner; room temperature; outside temperature; state of vehicle-mounted audio-visual equipment; state of setting of an automatic driving function; operation status of windshield wipers; remaining fuel level; remaining battery level; ratio of engine/battery on which power depends (in the case of a hybrid car); remaining oil level; radiator temperature; and engine temperature.

Further, the DPF-ECU 250 obtains motion pictures such as a navigation image from a motion picture generating device (not shown) such as a navigator included in the automobile, causes the obtained motion picture to be reflected in the scene design created by the instrument panel development support tool 110 of the display scene creation system 100, and causes the motion-picture-reflected scene design to be displayed in the display area of the liquid crystal display device 210.

Further, when the touch panel 220 detects a touch by the user on the scene design displayed in the display area of the liquid crystal display device 210, in the case where both of a rectangular area where a coordinate sequence at which the touch by the user is detected is present, and a gesture indicated by the coordinate sequence in the rectangular area, match both of a sub-event and a gesture associated with the sub-event, respectively, the DPF-ECU 250 refers to the scene design transition information storage section 240, retrieves a corresponding post-transition scene design out of the scene design storage section 230, and causes the retrieved scene design to be displayed in the display area of the liquid crystal display device 210.

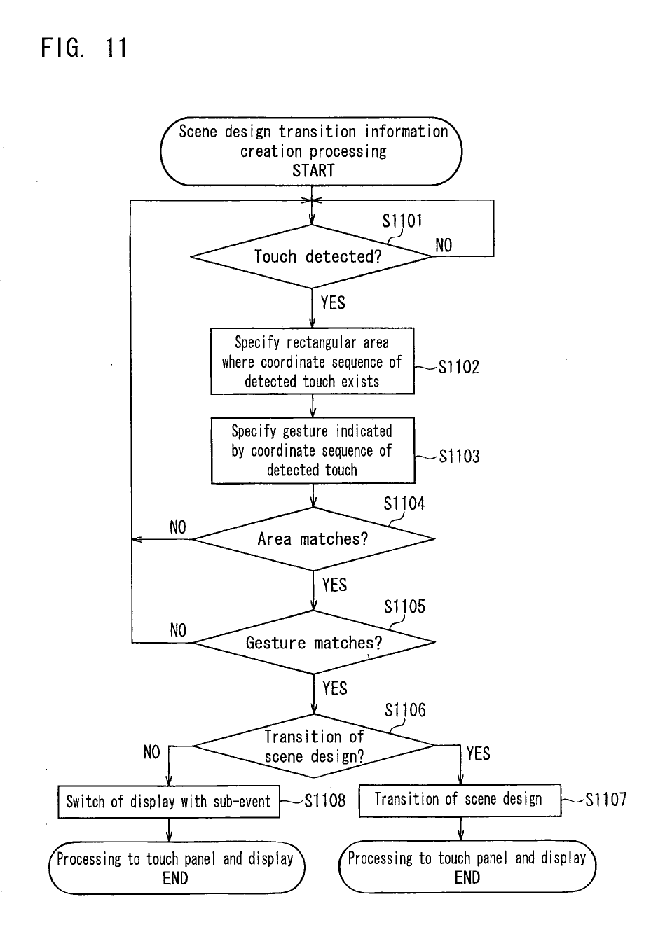

Hereinafter, explanation is made regarding a processing with respect to the touch panel and display in which the scene design displayed by the liquid crystal display device 210 has a transition, with reference to the flowchart shown in FIG. 11.

First, the DPF-ECU 250 determines whether or not the touch panel 220 detects a touch by the user (Step S1101). In the case where it is determined at the step S1101 that no touch is detected, the DPF-ECU 250 ends the processing. On the other hand, in the case where it is determined that a touch is detected at the step S1101, the DPF-ECU 250 specifies a rectangular area where a coordinate sequence at which the touch by the user was detected is present (Step S1102), and further, specifies a gesture indicated by the coordinate sequence at which the touch was detected (Step S1103). Here, on the basis of X, Y coordinate values provided by the touch panel 220 and information registered in the scene design transition information storage section 240, the DPF-ECU 250 carries out area determination with use of a CAN microcomputer, and specifies the rectangular area. More specifically, on the basis of the first value of the X, Y coordinate value sequence provided by the touch panel 220, the DPF-ECU 250 carries out the area determination with reference to the image information (upper-left X, Y coordinates, and vertical and horizontal lengths of image) registered in the scene design storage section 230, and if there is a rectangle that matches the determination, the flow goes onto the next step. The DPF-ECU 250 determines a gesture, on the basis of the X, Y coordinate value sequence provided by the touch panel. Referring to the rectangle that matches the determination, and the gesture, the DPF-ECU 250 determines whether or not any event that matches them exists. Then, the DPF-ECU 250 carries out the area determination with reference to the image information (upper-left X, Y coordinates, and vertical and horizontal lengths of image) registered in the scene design storage section 230, thereafter, carries out determination with reference to the gestures registered in the scene design transition information storage section 240, and carries out the area determination with use of the CAN microcomputer, so as to specify the rectangular area.

Next, the DPF-ECU 250 determines whether or not the specified rectangular area where the coordinate sequence is present matches a sub-event (Step S1104).

If it is determined at Step S1104 that they do not match each other, the DPF-ECU 250 ends the processing. On the other hand, if it is determined at Step S1104 that they match each other, the DPF-ECU 250 determines whether or not the specified gesture indicated by the coordinate sequence matches the gesture associated with the sub-event (Step S1105).

In the case where it is determined at Step S1105 that they do not match each other, the DPF-ECU 250 ends the processing. On the other hand, in the case where it is determined at Step S1105 that they match each other, the DPF-ECU 250 determines whether or not the scene design transition processing should be carried out (Step S1106). In the case where it is determined at Step S1106 that the scene design transition processing should be carried out, the DPF-ECU 250 refers to the scene design transition information storage section 240, causes the sub-event to blink for a set transition time, and thereafter causes a post-transition scene design, retrieved from the scene design storage section 230, to be displayed in the display area of the liquid crystal display device 210 (Step S1107). On the other hand, in the case where it is determined at Step S1106 that the scene design transition processing should not be carried out, the DPF-ECU 250 switches the display in accordance with the sub-event (Step S1108).

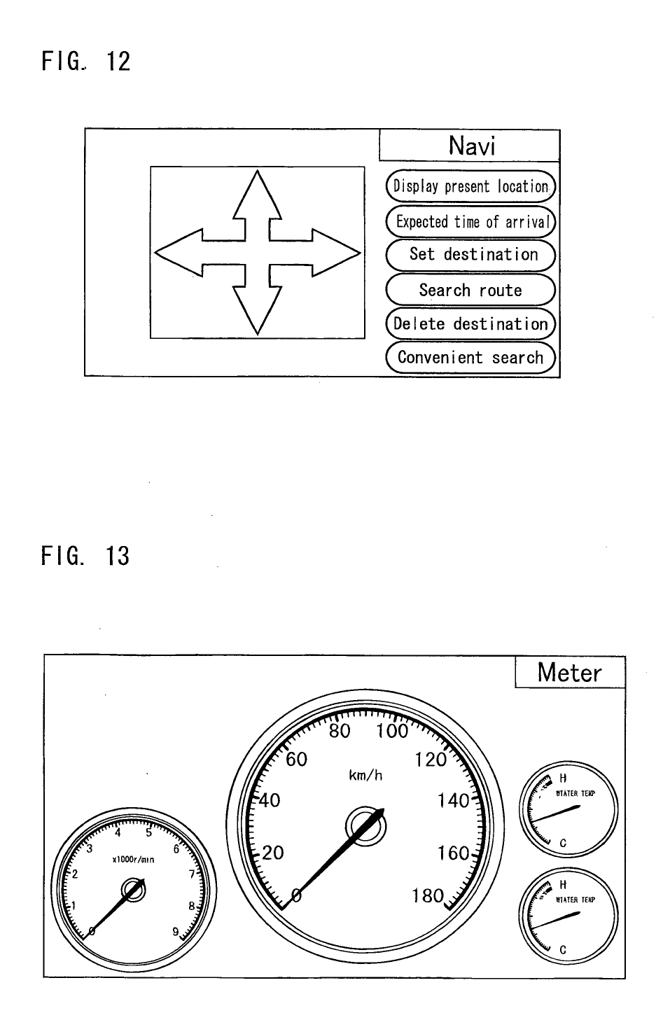

For example, when an input by a certain gesture is made to the touch panel 220 with respect to the sub-event “NaviButtonOn” in the “MainMenu” of the scene design “Initial”, the display of the sub-event “NaviButtonOn” blinks for 100 ms, and then the post-transition scene design “Navi” is displayed in the display area of the liquid crystal display device 210 as shown in FIG. 12. When an input by a certain gesture is made to the touch panel 220 with respect to the sub-event “MeterButtonOn” in the “MainMenu” of the scene design “Initial”, the display of the sub-event “MeterButtonOn” blinks for 100 ms, and then the post-transition scene design “Meter” is displayed in the display area of the liquid crystal display device 210 as shown in FIG. 13.

As explained above, the present invention makes it possible to provide a display scene creation system, a display scene creation program, a touch panel-equipped display system, a driver side control module, and a mobile object that are capable of causing a scene design to make a transition when a gesture is input to a touch panel, without any processing program that relates the touch panel to the gesture.

Further, an item is defined with a rectangular area indicated by coordinates in a display area of a display device, and therefore a post-transition scene design can be retrieved by determining whether or not both of a rectangular area in which a coordinate sequence input to a touch panel is present, and a gesture indicated by the coordinate sequence in the rectangular area match both of an area of a sub-event and a gesture associated with the sub-event, respectively. Accordingly, the present invention makes it possible to provide a display scene creation system, a display scene creation program, a touch panel-equipped display system, a driver side module, and a mobile object that are capable of causing a scene design to make a transition without any processing program that relates the touch panel to the gesture.

Further, one layer is allocated to each scene design. Therefore, the present invention makes it possible to provide a display scene creation system, a display scene creation program, a touch panel-equipped display system, a driver side control module, and a mobile object that are characterized in that even if scene designs are set in a plurality of layers, an inconvenience is prevented from occurring in input to the touch panel due to the overlap of scene designs.

Further, since a scene design is allowed to make a transition by the DPF-ECU 250 without any processing program that relates the touch panel to gestures, it is possible to provide a system in a simple configuration at a lower price.

Further, a touch panel-equipped display system according to the present embodiment is capable of displaying, not only a state of a mobile object such as a car, but also together, for example, a video picked up as to a view outside a car, a video stored in a storage medium installed in a car or the like, a video obtained by communication with outside, and any other arbitrary images (freeze-frame pictures or motion pictures), as well as additional information such as character information.

Further, though a liquid crystal display device is used in the above-described embodiment, the object to which the present invention is applied is not limited to a touch panel-equipped display system in which a liquid crystal display device is used. Any display device can be used, as long as it is a display device in which at least a section where a scene design is displayed is of the dot-matrix type.

Further, the objects to which the present invention can be applied are not limited to the vehicle-mounted touch-panel-equipped display system incorporated into the instrument panel as described above. The present invention can be applied to any touch panel-equipped display system having a function of causing a display scene to make a transition according to an input gesture, and the use thereof and the hardware configuration of the same vary widely. For example, the present invention can be applied to any use such as game machines, portable telephones, portable music players, PDAs (personal digital assistants), vending machines, interactive information boards, terminal equipment for search, interphones, and liquid crystal photo frames, although these are merely examples.

It should be noted that the present invention includes a case where software programs that realize the above-described embodiment (as to the embodiment, programs corresponding to the flowcharts illustrated in the drawings) are supplied to a device and a computer of the device reads the supplied programs and executes the same. Therefore, the programs themselves that are to be installed in the computer so as to realize the functions and processes of the present invention with the computer also embody the present invention. In other words, the present invention also covers the program for realizing the functions and processes of the present invention.

The configuration explained above regarding the embodiment merely represents a specific example, and does not limit the technical scope of the present invention. Any configuration can be adopted as long as it achieves the effects of the present invention.

### DESCRIPTIONS OF REFERENCE NUMERALS

100 display scene creation system
110 instrument panel development support tool
111 scene design setting section
112 item table
113 item setting section
120 scene design director
121 gesture table
122 gesture setting section
123 scene design transition table
200 touch panel-equipped display system
210 liquid crystal display device
220 touch panel
230 scene design storage section
240 scene design transition information storage section
250 DPF-ECU

1. A display scene creation system comprising:
a display scene design setting section for setting a design of a display scene;
a display component setting section for setting one or more display components to be displayed in the design of the display scene set by the display scene design setting section;
a gesture setting section for setting a gesture with which the display scene makes a transition when the gesture is input to the display components set by the display component setting section; and
a transition display scene table for storing the gesture set by the gesture setting section and a post-transition display scene where the gesture and the post-transition display scene are associated with each other.

2. The display scene creation system according to claim 1, wherein the display component setting section sets a display component defined with a rectangular area indicated by coordinates present in the display scene.

3. The display scene creation system according to claim 1, wherein the display scene design setting section allocates one layer to each display scene so as to set the design of the display scene.

4. A display scene creation program that causes a computer to execute the steps of:
setting a design of a display scene;
setting one or more display components to be displayed in the design of the display scene set at the display scene design setting step;
setting a gesture with which the display scene makes a transition when the gesture is input to the display components set at the display component setting step; and
associating the gesture set at the gesture setting step with a post-transition display scene.

5. The display scene creation program according to claim 4, wherein, at the display component setting step, a display component defined with a rectangular area indicated by coordinates present in the display scene is set.

6. The display scene creation program according to claim 4, wherein, at the display scene design setting step, one layer is allocated to each display scene so that the design of the display scene is set.

7. A touch panel-equipped display system including a display device, and a touch panel having a detection area where a touch by a user is detected, the touch panel being provided all over a display area of the display device, the touch panel-equipped display system comprising:
a display control section that, when the touch panel detects a touch by a user on a display scene displayed in the display area of the display device, displays a post-transition display scene in the display area of the display device on the basis of a display component at which the touch by the user was detected and a gesture input with respect to the display component.

8. The touch panel-equipped display system according to claim 7,
wherein the display component is defined with a rectangular area indicated by coordinates in the display area of the display device, and
when the touch panel detects a touch by the user on the display scene displayed in the display area of the display device, in the case where both of a rectangular area where a coordinate sequence at which the touch by the user is detected is present, and a gesture indicated by the coordinate sequence in the rectangular area, match both of an area of the display component and a gesture associated with the area of the display component, respectively, the display control section causes a post-transition display scene to be displayed in the display area of the display device.

9. The touch panel-equipped display system according to claim 7, wherein the display device is a liquid crystal display device.

10. A driver side control module that is provided near a driver seat of a mobile object, the driver side control module comprising the touch panel-equipped display system according to claim 7.

11. A mobile object comprising the touch panel-equipped display system according to claim 7, wherein the display device is provided at a position visible at least from a driver seat.

12. The mobile object according to claim 11,
wherein the mobile object is an automobile, and
the touch panel-equipped display system is connected with electronic control units of respective sections of the automobile via a control area network.
